(19) United States
(12) Patent Application Publication
(10) Pub. No.: US 2026/0116578 A1
(43) Pub. Date: Apr. 30, 2026

(54) JUNCTION DEVICE FOR AIRCRAFT ALLOWING A DEGREE OF FREEDOM IN ONE DIRECTION

(71) Applicant: Airbus Operations SAS, TOULOUSE (FR)

(72) Inventor: Bernard ROLLAND, TOULOUSE (FR)

(21) Appl. No.: 19/368,577

(22) Filed: Oct. 24, 2025

(30) Foreign Application Priority Data
Oct. 25, 2024 (FR) FR2411668

(51) Int. Cl. B64F 5/10; B64C 1/06

(52) U.S. Cl. CPC B64F 5/10; B64C 1/061

(57) ABSTRACT

A device for joining a first element of an aircraft to a second element of the aircraft. The device has a first connecting part intended to be integral with the first element and a second connecting part intended to be integral with the second element. The device also has an oblong ring, a connecting pin arranged in the oblong ring so as to be locked in the oblong ring in a first direction and free in a second direction, and at least one pad of elastomeric material in which the connecting pin is inserted so as to reduce the movement of the connecting pin in the second direction.

### CROSS-REFERENCE TO RELATED APPLICATIONS

This application claims priority to French Patent Application No. FR2411668 filed on Oct. 25, 2024, the entire disclosure of which is incorporated herein by way of reference.

### FIELD OF THE INVENTION

The present invention relates to a junction device for an aircraft.

### BACKGROUND OF THE INVENTION

In flight, especially in cruise flight, an aircraft is subjected to external temperatures of up to −50° C., while the interior is kept at temperatures generally between 20° C. and 24° C. This large temperature difference subjects the aircraft structure to high stresses, such as, for example, thermal compression in a longitudinal direction, which notably causes a forced deformation of the cockpit floor with respect to the fuselage, and may damage the cockpit floor.

The aim of the invention is to at least partially overcome this drawback.

### SUMMARY OF THE INVENTION

For this purpose, a device is proposed for joining a first element of an aircraft to a second element of an aircraft, comprising a first connecting portion intended to be secured to said first element and a second connecting portion intended to be secured to said second element, the first connecting portion comprising an oblong ring, the device comprising a connecting pin arranged in the oblong ring so as to be immobilized in the ring in a first direction and free in a second direction, the device comprising at least one pad made of elastomeric material into which the connecting pin is inserted so as to reduce the displacement of the connecting pin in the second direction.

The anisotropic behavior of the device as claimed in the invention, which immobilizes in the first direction and enables a slowed translational movement in the second direction, prevents the deformation of the floor when the aircraft is in flight from generating a significant load in the junction in the second direction. Moreover, in the first vertical direction, the load coming from the cockpit floor can be rigidly transferred from the longitudinal beam to the transverse beam, by mechanical contact between the metal parts, specifically the connecting pin and the oblong ring.

According to another aspect, the second direction is orthogonal to the first direction.

According to another aspect, a diameter of the connecting pin coincides with a width of the oblong ring.

According to another aspect, the device comprises at least two cylindrical rings stacked along the connecting pin, each of said cylindrical rings being inserted into said at least one elastomer pad.

According to another aspect, the device comprises three stacked cylindrical rings.

According to another aspect, the device comprises at least one first elastomer pad and at least one second elastomer pad arranged on both sides of the oblong ring, the connecting pin being inserted into each of the elastomer pads.

According to another aspect, the elastomer has a rigidity of less than or equal to 3000 N/mm.

According to another aspect, the connecting pin is made of steel.

According to another aspect, the oblong ring is made of cupronickel.

The invention also relates to an aircraft comprising a junction device as described above.

According to another aspect, the first element is a cross member of the fuselage, for example of a cockpit floor, and the second element is a longitudinal fuselage beam.

The invention also relates to a device for joining a first element of an aircraft to a second element of an aircraft, the device comprising a first connecting portion intended to be secured to said first element and a second connecting portion intended to be secured to said second element, the device comprising an oblong housing, the device comprising a connecting pin arranged in the oblong ring, the device comprising means for fixing the pin in a first direction, shaped so that the pin bears rigidly against said oblong housing in said first direction, the device also comprising means for fixing the pin in a second direction orthogonal to the first direction, shaped so that the pin bears flexibly in said oblong housing.

### BRIEF DESCRIPTION OF THE DRAWINGS

Further features, details and advantages will become apparent on reading the detailed description below, and on studying the attached drawings, in which:

FIG. 1 is a schematic side view of a junction device for joining a first panel of an aircraft to a second panel of an aircraft according to an embodiment of the present invention; and,

FIG. 2 is a schematic view of a section in a direction A-A of the junction device in FIG. 1.

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements which, although not explicitly described or represented here, nevertheless embody the principles of the present invention and are included in its spirit and scope.

Furthermore, to facilitate understanding, the following description may describe relatively simplified implementations of the present invention. As a person skilled in the art will understand, other implementations of the present invention may be of greater complexity.

In some cases, examples of modifications of the present invention may also be presented. This is done simply to aid understanding, again rather than define the scope or establish the limits of the present invention. These modifications are not an exhaustive list, and a person skilled in the art may make other modifications while still remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future.

In the figures, an orthonormal reference system (X, Y, Z) has been illustrated to simplify understanding of the description of the present invention. The direction Z corresponds to a vertical direction (yaw axis), the direction X corresponds to a longitudinal direction of the aircraft (roll axis), and the direction Y corresponds to a transverse direction (pitch axis).

As shown in the figures, the subject of the invention is a device, referenced 1 in the figures, for joining an element of the aircraft to a second element of the aircraft.

In the embodiment illustrated, and in a non-limiting manner, the first element is a cross member, for example of the cockpit floor of the aircraft, and the second element is a longitudinal beam.

The junction device 1 comprises a first portion 2, intended to be secured to the cross member, and a second portion 3, intended to be secured to the longitudinal beam.

In the embodiment illustrated, and in a non-limiting manner, the first portion 2 is a junction fitting while the second portion 3 is a fork.

As shown in the figures, the junction fitting 2 is secured to the cross member 4 of the aircraft by a set of angle brackets 5, for example by screwing or riveting.

As also shown in the figures, the fork 3 comprises a main branch 6 which is split in the direction X into two branches 7, 8, referred to as the upper and lower branches respectively, which are spaced apart from each other so as to delimit an internal volume V of the fork 3.

The junction device 1 comprises a connecting pin 9 extending longitudinally in the direction Y. The connecting pin 9 is preferably made of 45NCD16 steel.

As shown in the figures, the junction fitting 2 comprises a housing provided with an oblong ring 10 in which the connecting pin 9 is inserted. Preferably, the oblong ring 10 is made of cupronickel, in order to reduce the coefficient of friction between the connecting pin 9 and the oblong ring 10, thereby minimizing the effect of wear between the connecting pin 9 and the oblong ring 10.

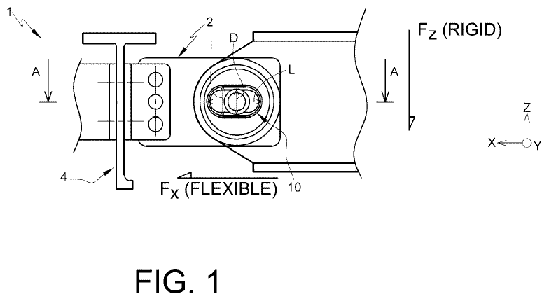

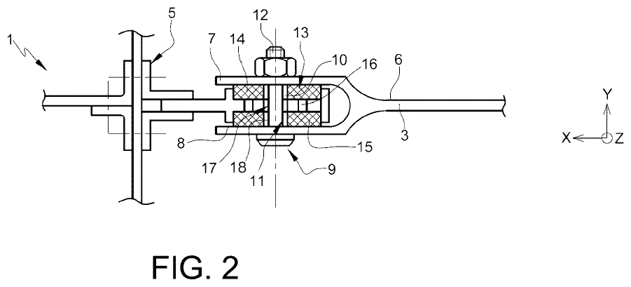

The dimensions of the connecting pin 9 and of the oblong ring 10 are such that the pin 9 bears against the oblong ring 10 in the direction Y while the pin 9 is free in the direction X, as shown clearly in FIGS. 1 and 2. As shown in FIG. 1, a diameter D of the pin 9 coincides with a width L of the ring 10, which helps to immobilize the pin in the directions Y and Z. As shown in FIGS. 1 and 2, the diameter D of the pin 9 is strictly less than a length L of the ring 10, which leaves the pin 9 free in the direction X.

The junction device 1 comprises rigid fixing means 11 for fixing the connecting pin 9 against the oblong ring 10 in the direction Z. The rigid fixing means 11 for example comprise a nut 12 placed against the oblong ring 10.

As shown in FIGS. 1 and 2, the connecting pin 9 is arranged at a distance from the oblong ring 10 in at least one plane (X, Y).

The junction device 1 also comprises flexible fixing means 13 for fixing the connecting pin 9 in the direction X. The flexible fixing means 13 comprise at least one pad made of elastomeric material, secured to the junction fitting 2. The elastomer advantageously has a low rigidity, preferably less than or equal to 3000 N/mm. Each pad limits the displacement of the connecting pin 9 in the direction X.

In the embodiment illustrated, the junction device 1 comprises two elastomer pads 14, 15 arranged in the internal volume V of the fork 3. The pad 14 is arranged against the junction fitting 2, the upper branch 7 and the oblong ring 10. The pad 15 is arranged against the junction fitting 2, the lower branch 8 and the oblong ring 10.

The junction device 1 also comprises at least one cylindrical ring for clamping the connecting pin 9. In the embodiment illustrated, the junction device 1 comprises three cylindrical rings stacked in the direction Y, referred to as the upper ring 16, the central ring 17 and the lower ring 18, respectively. Each of the cylindrical rings 16 to 18 is preferably made of 45NCD16 steel. Stacking the cylindrical rings 16 to 18 in the direction Y enables the pin 9 to be clamped without prestressing the fork 3. The mechanical contact between each cylindrical ring and the connecting pin 9 is part of the rigid fixing means 11.

As shown particularly in FIG. 2, the upper cylindrical ring 16 bears against the elastomer pad 14, while the lower cylindrical ring 18 bears against the elastomer pad 15. The bearing of the connecting pin 9 against the pads 14, 15 ensures the flexible bearing of the pin 9 in the direction X.

As shown in FIG. 2, the connecting pin 9 passes through the upper and lower branches 6, 7 of the fork 3, the oblong ring 10 and the elastomer pads 14 and 15, in the direction Y.

Thus, the rigid fixing means 11 comprising the rigid contact of the pin against the metal parts (branches 6, 7 of the fork 3, cylindrical rings 16 to 18, oblong ring 10) and the tightening by nut or washer, ensures a degree of freedom of zero in the direction Z. The flexible fixing means 13 comprising each elastomer pad 14, 15 ensure a degree of freedom that is not zero in the direction X. In other words, the device 1 makes it possible to form a junction between the elements of the aircraft that allows a displacement in one direction (the direction X in the figures) by using elastomer, while preventing displacement in one or more other perpendicular directions by rigid mechanical contact (the directions Y and Z in the figures). The device 1 simultaneously comprising the elastomer pads and a rigid contact between the metal parts (connecting pin and fork, connecting pin and oblong ring) ensures the anisotropic behavior of the device 1. In the longitudinal direction (X), the elastomer pads 14, 15 allow smooth displacement due to the low rigidity of the elastomer (less than 3000 N/mm), such that the deformation of the floor when the aircraft is in flight does not generate a significant load in the junction 1. In the vertical direction Z, the load coming from the cockpit floor is rigidly transferred from the longitudinal beam to the transverse beam, by mechanical contact between the metal parts, specifically the connecting pin 9, the cylindrical rings 13 and the oblong ring 10.

Moreover, the junction fitting 2 is held by the angle brackets 5 on the cross member 4 in order to redirect the forces applied to the cockpit floor back into the hybrid elastomer-metal junction.

Modifications and improvements to the implementations described above of the present invention may occur to a person skilled in the art. In particular, the embodiments and variants described can be combined, provided that they are not incompatible. The above description is illustrative by means of examples rather than limiting. The scope of the present invention is therefore limited solely by the scope of the claims below.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A device for joining a first element of an aircraft to a second element of the aircraft, the device comprising:
a first connecting portion configured to be secured to said first element;
a second connecting portion configured to be secured to said second element;
an oblong ring;
a connecting pin arranged in the oblong ring so as to be immobilized in the oblong ring in a first direction and free in a second direction; and,
at least one pad made of elastomeric material into which the connecting pin is inserted so as to reduce a displacement of the connecting pin in the second direction.

2. The device as claimed in claim 1, wherein a diameter of the connecting pin coincides with a width of the oblong ring.

3. The device as claimed in claim 1, further comprising:
at least two cylindrical rings stacked along the connecting pin, each of said at least two cylindrical rings inserted into said at least one pad.

4. The device as claimed in claim 3, wherein the at least two cylindrical rings comprises three cylindrical rings.

5. The device as claimed in claim 1, wherein the at least one pad comprises at least one first elastomer pad and at least one second elastomer pad, the at least one first elastomer pad and the at least one second elastomer pad arranged on opposite sides of the oblong ring, and
wherein the connecting pin is inserted into both the at least one first elastomer pad and the at least one second elastomer pad.

6. The device as claimed in claim 1, wherein the elastomeric material has a rigidity of less than or equal to 3000 N/mm.

7. The device as claimed in claim 1, wherein the connecting pin is made of steel.

8. The device as claimed in claim 1, wherein the oblong ring is made of cupronickel.

9. An aircraft comprising:
a first element, the first connecting portion is secured to said first element;
a second element, the second connecting portion secured to said second element; and,
the device as claimed in claim 1.

10. The aircraft as claimed in claim 9, wherein the first element is a cross member of a fuselage and the second element is a longitudinal fuselage beam.
